(19) United States
(12) Patent Application Publication
(10) Pub. No.: US 2025/0139608 A1
(43) Pub. Date: May 1, 2025

(54) Card System Utilizing On-Chain Managed Redeemable Gift Code

(71) Applicant: Wood Brothers Steel Stamping Company, Wheeling, IL (US)

(72) Inventor: Chad G. Scully, Lake Geneva, WI (US)

(21) Appl. No.: 18/930,857

(22) Filed: Oct. 29, 2024

Related U.S. Application Data
(60) Provisional application No. 63/605,498, filed on Dec. 2, 2023.
(60) Provisional application No. 63/546,230, filed on Oct. 29, 2023.

(51) Int. Cl. G06Q 20/34; G06Q 20/38

(52) U.S. Cl. CPC G06Q 20/342; G06Q 20/389

(57) ABSTRACT

Using a dual smart contract system that separates the management of gift codes into two distinct layers, a public smart contract and a private smart contract. This architecture enhances security, transparency, and control in gift code management, offering significant advancements over existing methods.

### CROSS-REFERENCE TO RELATED APPLICATIONS

This patent application claims priority to (1) provisional patent application entitled “Method and System for Generating and Managing Blockchain-Integrated Redeemable Codes,” filed on Dec. 2, 2023, having Ser. No. 63/605,498, and (2) provisional patent application entitled “Cards with On-Chain Managed Redeemable Gift Code for Associated NFT and/or Tokens,” filed on Oct. 29, 2023, having Ser. No. 63/546,230. Both of these two provisional patent applications referenced immediately above in this paragraph are both hereby incorporated by reference in their entirety.

### BACKGROUND OF THE INVENTION

### Field of the Invention

The present invention relates generally to the management and redemption of physical and digital gift cards, and more specifically, through the use of blockchain technology.

### Description of Related Art

Traditional gift code systems are centralized, leading to several issues such as security risks, lack of transparency, and limited flexibility. Central databases are susceptible to hacking, fraud, and unauthorized access. Users cannot independently verify the status of their gift codes, and changing gift code statuses or associated content is private and prone to security implications like verifiability.

Accordingly, there is a need for an improved gift code system that overcomes these deficiencies in both physical and digital gift card systems.

### ASPECTS AND SUMMARY OF THE PRESENT INVENTION

One aspect of the present invention is to provide a system for both physical and digital gift cards that is more secure.

Another aspect of the present invention is to provide a system for utilizing physical and digital gift cards that is more transparent to merchants and user.

A further aspect of the present invention is to increase the flexibility for providers and users of physical and digital gift cards.

In order to achieve these aspects and others, the present invention provides a system that transforms the management and redemption of gift codes linked to physical or digital cards. By integrating blockchain technology, specifically through the use of public and private smart contracts, the present invention addresses the shortcomings of traditional, centralized gift code management systems. The present invention enhances security, transparency, and flexibility, offering a significant improvement over existing methods by using smart contracts in blockchain technology. A blockchain is a decentralized, distributed ledger technology that records transactions across multiple computers in a way that ensures the data is immutable and transparent. Each block contains a list of transactions and is linked to the previous block, forming a chain that cannot be altered retroactively without the alteration of all subsequent blocks and the consensus of the network.

The present invention improves security concerns with gift cards by storing sensitive gift code information in a private smart contract and preventing unauthorized access. The present invention increases transparency by allowing users to verify the status of their gift codes through a public smart contract. Moreover, the present invention improves flexibility by enabling administrators and authorized users to dynamically manage gift codes via the public smart contract without compromising security. Administrators and users can be validated by using an assigned blockchain wallet address. Wallet addresses are highly unique digital identities generated and verified using cryptographic techniques. Meaning it is highly unlikely one could ever fraudulently submit transactions without authority to do so. Thus, securing the memory state of both the private and public smart contract.

The use of blockchain technology often comes with gas fees set by validators within the blockchain network. Gas fees are often used to secure and ensure it is economically inconvenient for one to attack blockchain networks with brute force and more. The present invention ensures sensitive information like gift codes are economically inconvenient to brute force guess and more.

The present invention is a further improvement over centralized database and processing techniques due to consensus. Blockchains often rely on the consensus of multiple validator nodes that agree on the current state of a smart contract and the blockchain in whole. This ensures no single bad actor can silently change or otherwise impact the blockchain state without detection from the other network validators or even the public. Further validating and improving confidence of one in possession of a physical or digital gift card.

Traditional and centralized systems can certainly result in digital blockchain assets like tokens upon redemption. But tying the Gift Code to blockchain technology further improves user experience, especially when the redemption results in blockchain based tokens or content. This is because both redemption transactions and asset transfer transactions can be viewed across multiple blockchains with the same or similar verifiable integrity. The present invention provides a more seamless experience within blockchain based ecosystems.

Blockchain tokens and alike are popularly used to identify physical items in the physical world, but upon the digital and immutable ledger provided by the blockchain. Meaning this improved use of blockchain powered gift codes, expands to both physical and digital items. In other words, gift codes in the present invention can result in the redeemer gaining access to physical and or digital experiences and or items.

As the present invention seamlessly bridges users with blockchain technology, it provides a better way to onboard users to blockchain. With the vast methods for one to interact with a blockchain, the use of smart-contract based wallets further improves the present invention over current systems. The redeemer upon redemption can be provided access to a smart contract which acts as a wallet for the user, holding digital assets associated with the gift codes status on the public smart contract. This smart-contract wallet can sometimes also execute transactions on behalf of the redeemer, and even store other blockchain based assets like tokens. Smart-contract based wallets also can be executed by authorized executors, on behalf of the redeemer.

There are two types of smart contracts utilized by the present invention, both public contracts and smart contracts. A core innovation of the present invention lies in how a public smart contract directly influences the redemption process managed by the private smart contract, ensuring that sensitive information remains secure, while providing dynamic and verifiable control over gift code redemption.

Smart contracts are self-executing code contracts with the terms written into code. Smart contracts are often executed as part of a transaction terminated by either another smart contract or an externally owned account. Smart contracts automatically enforce and execute agreements when predefined conditions are met.

Public smart contracts are accessible and visible to everyone on the blockchain network. Public smart contracts handle operations that benefit from transparency, such as managing the status of gift codes. Private smart contracts are restricted to authorized parties and not publicly visible. Private smart contracts handle sensitive data and operations, like storing and verifying the actual gift code and related data.

A novelty of the present invention lies in the use of a dual smart contract system that separates the management of gift codes into two distinct layers, a public smart contract and a private smart contract. This architecture enhances security, transparency, and control in gift code management, offering significant advancements over existing methods.

The public smart contract manages non-sensitive information and controls redemption policies without exposing the actual gift codes. It allows administrators and authorized users to dynamically update the status of gift codes, such as freezing or unfreezing them, or to change the associated content. These actions directly influence whether a gift code can be redeemed and what it unlocks, all without revealing any sensitive information. The public smart contract serves as an accessible interface for policy enforcement and status tracking, ensuring transparency and user trust.

Simultaneously, the private smart contract securely stores and verifies the actual gift codes, often in an encrypted form like a hash and salt pair, or even keys, commitments, parameters and other data. This separation ensures that sensitive information remains confidential. The private smart contract handles the critical task of authenticating gift codes during redemption while keeping the codes hidden from unauthorized parties. The private smart contract has read and sometimes write access to the public smart contract's state, allowing the public smart contract's state to influence the redemption process within the private smart contract's execution.

An essential aspect of the present invention is how the private smart contract can be executed securely either on a permissioned blockchain or off-chain in a Trusted Execution Environment (TEE). In a permissioned blockchain, the private smart contract resides within a network where access is restricted to authorized participants. This controlled environment ensures that only trusted nodes can interact with sensitive data, often providing confidentiality and compliance with regulatory standards. It leverages the blockchain's immutable ledger for secure transaction recording while maintaining strict access control.

Alternatively, the private smart contract can be processed off-chain within a trusted execution environment. A TEE is a secure area that guarantees code and data loaded inside are protected with respect to confidentiality and integrity. By executing the private smart contract in a TEE, the system isolates sensitive computations from the main blockchain network. This method allows for secure validation of gift codes without exposing them, enhancing scalability and interoperability with other systems. TEE's often store their smart contract states offline in a secured database. TEEs also often submit receipts, void of any sensitive information related to the transaction which occurred within the TEE, to the public or permissioned blockchain state.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1 illustrates a high-level flowchart of a method of the present invention;

FIG. 2 illustrates an example of how one may implement the present invention in a blockchain network topology;

FIG. 3 illustrates a subprocess of how a user can securely generate Redeemable Gift in accordance with the present invention;

FIG. 4 illustrates a subprocess of distributing the redeemable gift code in accordance with the present invention;

FIG. 5 shows a subprocess for illustration for digital cards in accordance with the present invention;

FIG. 6 illustrates a subprocess for notifying an administrator of a lost or stolen physical or digital card in accordance with the present invention;

FIG. 7 illustrates a subprocess for a private smart contract processing a redeemable gift code in accordance with the present invention;

FIG. 8 illustrates a subprocess for a private smart contract processing a hash of a redeemable gift code in accordance with the present invention;

FIG. 9 illustrates a subprocess for a user to gain access to a smart contract-based wallet using a redeemable gift code in accordance with the present invention;

FIG. 10 illustrates a subprocess for a user to gain access to a private key using a redeemable gift code in accordance with the present invention;

FIG. 11 illustrates a subprocess for a user to gain access to a token using a redeemable gift code in accordance with the present invention;

FIG. 12 illustrates a subprocess for a user to gain access to an experience or item using external API in accordance with the present invention;

FIG. 13 illustrates a subprocess for a user to distribute a token using a redeemable gift code in accordance with the present invention;

FIG. 14 illustrates a subprocess for a user to publically verify the status of a redeemable gift code in accordance with the present invention;

FIG. 15 illustrates a subprocess for a user to update gift code status to frozen or not frozen in accordance with the present invention;

FIG. 16 illustrates a subprocess for a user to update gift code status to result in A or B content in accordance with the present invention;

FIG. 17 illustrates a clear text alphanumeric Gift Code and exemplifies the Gift Codes structure in accordance with the present invention;

FIG. 18 illustrates a unique identifier generated from but not limited to an ethereum wallet or contract address in accordance with the present invention;

FIG. 19 illustrates two cards with the basic shape and size of a business card made of no specific material containing the clear text Gift Code with one that is covered by an optional scratch off or peel off covering and the other without the scratch off or peel off covering in accordance with the present invention;

FIG. 20 illustrates an odd non-standard shaped card made of no specific material containing the clear text Gift Code that is covered by an optional covering to protect undesired exposure of the gift code in accordance with the present invention;

FIG. 21 illustrates a sticker made of no specific material and an adhesive backing meant to be applied to various objects in accordance with the present invention;

FIG. 22 illustrates a bifold card of no specific material with figures on the front with the clear text Gift Code that is covered by an optional covering on the interior in accordance with the present invention;

FIG. 23 illustrates a transaction receipt made of no specific material that has been printed and contains a redeemable Gift Code in accordance with the present invention;

FIG. 24 illustrates a computer screen which shows the Gift Code being entered into an input field for redemption and then the resulting NFT and the accompanying card in accordance with the present invention; and

FIG. 25 illustrates a computer screen that contains a digital card which displays a Gift Code and the associated unique ID in accordance with the present invention.

### DETAILED DESCRIPTION OF THE PREFERRED EMBODIMENTS

Referring to the figures, the following detailed description is intended to define in a non-limiting manner how the present invention may be implemented using relevant technology and components. It is important to note the following is only one of many ways one can implement and utilize the present invention. The following detailed description is intended to show subprocesses and blockchain network topology can occur in a variety of sequences. The following description ties all figures and Illustrations within this patent together in a single dialogue, giving context to each part of the invention components. Redeemable gift codes can be made of no specific character makeup or length. Redeemable gift codes will often have the default status of frozen within a public smart contract.

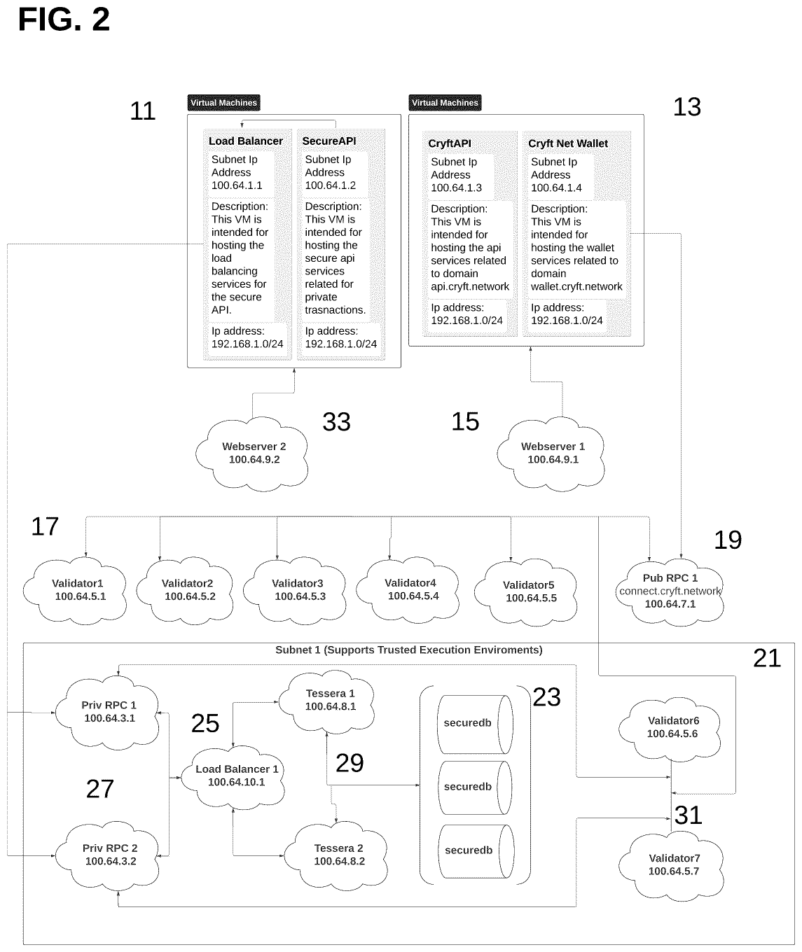

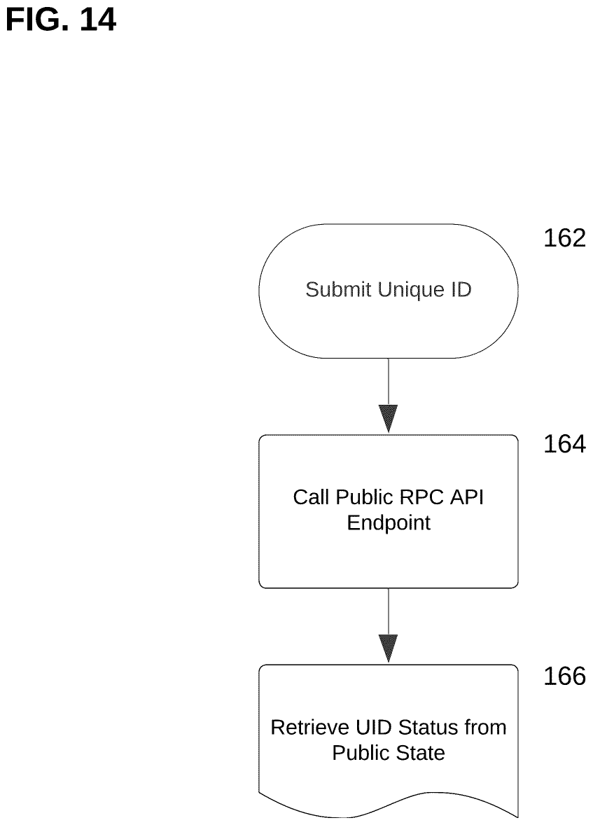

An important point within the present invention is how the public smart contract can influence the redemption process based on the public status, which can be viewed by anyone with blockchain state access as shown in FIG. 14 subprocess. When a user submits a Unique ID as shown in step a 162 of FIG. 14 of a redeemable gift code to the public smart contract. This is done by using the public RPC Endpoint at step 164 shown in topology flow chart step 19 of FIG. 2 to ultimately retrieve and return the status of the redeemable gift code at step 166 of FIG. 14.

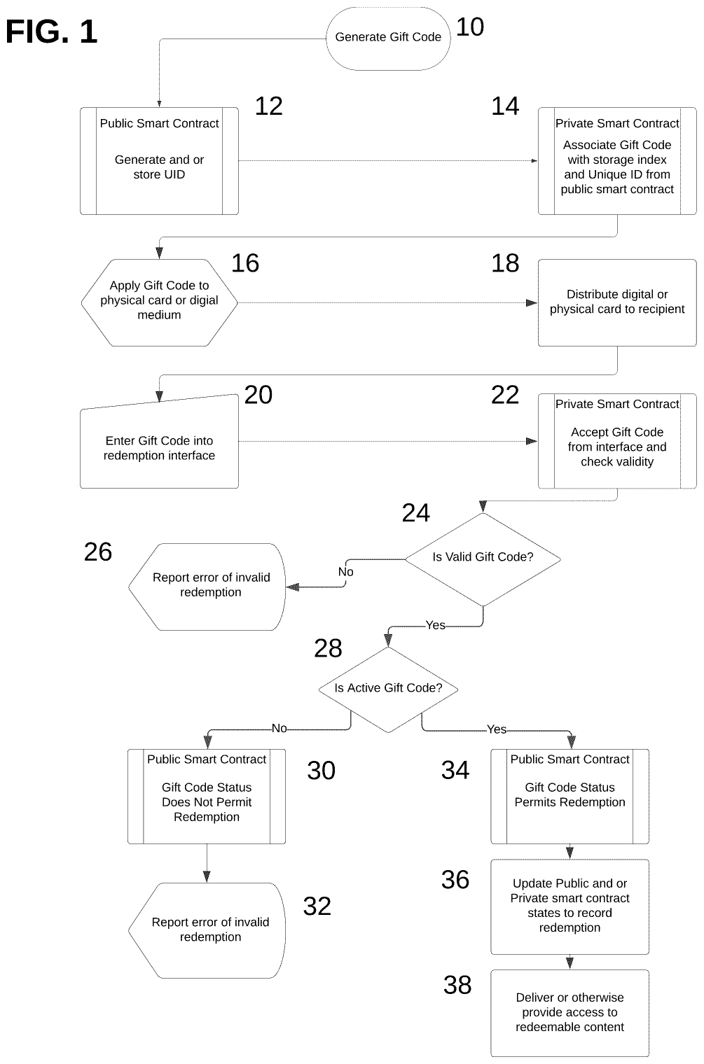

FIG. 1 illustrates a flow chart starting at gift code redemption and ending with conditional outcomes based on the validity of a Gift Code and the status of a Gift Code according to a public smart contract. In step 10 of FIG. 1 a redeemable code is generated, triggering the following steps. The gift code in step 12 is associated with a unique identifier in a public smart contract. Then in step 14 the encrypted representation of the redeemable gift code is associated with the Unique ID from step 12 and stored at an index within a private smart contract. Now we can display the gift code on a physical or digital medium at step 16 and distribute the redeemable code at step 18. With the Gift Code in possession of a user, the user can enter the redeemable code into an interface at step 20 which then directs the redeemable code to the private smart contract storing the redeemable code's encrypted representation. Then the private smart contract accepts the Gift Code at step 22 and if it finds the Gift Code is valid at step 24, the smart contract will then reference the public smart contract for redeemability status at step 28. Otherwise, the code is invalid and returns an error to the user at step 26. In step 30 we use the public smart contract to determine whether the Gift Code is permitted to be redeemed. If the status of the Gift Code in the public smart contract does not permit redemption then we return an error to the user at step 32. If the public smart contract does permit the Gift Code to be redeemed at step 34, then we continue the redemption process by updating the private and or public smart contract recording the redemption of the Gift Code at step 36. Then we transfer or otherwise provide access to the redeemable content at step 38.

FIG. 2 presents an example of how one may implement this invention. Done by utilizing a blockchain network architecture aimed at securely managing and processing gift codes, digital assets, and related transactions. It achieves this using a combination of virtual machines (VMs), trusted execution environments (TEEs), and blockchain validator nodes. The network is structured in a way which handles API services, wallet functions, load balancing, web interfaces, network validators and public/priv RPC nodes. While the container named Subnet 1, is a subnet dedicated to processing private transactions like gift code redemptions and validation using TEEs.

Virtual machines 11 dedicated to load balancing and secure API functions are used to enable one to safely transmit a gift code for redemption. The Load Balancer (100.64.1.1) efficiently manages incoming requests, distributing them across the network to ensure optimal performance. The SecureAPI (100.64.1.2) handles critical blockchain interactions, particularly those involving private smart contracts. This architecture ensures sensitive information, such as gift codes, is processed securely without exposure.

Alongside these components, there are virtual machines 13 responsible for managing the core Cryft network services. The CryftAPI (100.64.1.3) manages backend operations, handling requests from user-facing applications and communicating with both private and public blockchain elements. The Cryft Net Wallet (100.64.1.4) plays a crucial role in managing crypto assets, while securely interacting with the network.

Below features two Web Servers (100.64.9.1 (15) and 100.64.9.2 (33)), which host the virtual machines. These web servers essentially host backend services, handling transactions and facilitating queries to the blockchain. Additionally, within contains five Validator Nodes (100.64.5.1 to 100.64.5.5) (17) that play a key role in maintaining the network's consensus mechanism. These validators process and validate transactions, ensuring that the blockchain remains secure and that all operations are accurately recorded on the ledger.

A Public RPC Node (100.64.7.1) (19) provides a critical point of interaction for external systems and users. Through this node, external users can connect to the Cryft network to submit transactions, retrieve blockchain data, or check the status of digital assets and gift codes. This node ensures secure and seamless integration with the broader blockchain ecosystem.

The container labeled “Subnet 1” (21) of the diagram represents Subnet 1, which is specifically designed to support Trusted Execution Environments (TEEs) with the use of Tessera based privacy transaction managers. Two additional validator nodes, Validator 6 (100.64.5.6) and Validator 7 (100.64.5.7) (31), play a critical role in maintaining the consensus of blockchain Subnet 1. Blockchain Subnet1 is used to store the public smart contracts within this invention, and also record transaction receipts sent from the Tessera nodes, like when a gift redemption transaction occurs. These Tessera nodes are used for securely processing sensitive transactions off-chain. The Tessera nodes submit receipts of all transactions they process off-chain to the public Subnet 1 validator nodes. These secure Tessera nodes (100.64.8.1 and 100.64.8.2) (29) are responsible for handling private smart contracts, such as those related to gift code verifications, and ensure that all sensitive computations occur within a protected, confidential environment. The state of the smart contracts is then stored and updated using a secure database (23).

To facilitate secure communication between the validator nodes and the TEEs, Private RPC Nodes (100.64.3.1 and 100.64.3.2) (27) are deployed. These nodes handle communication between the private smart contracts and the validators, ensuring that all sensitive data is managed securely and only authorized participants can access the private contract states. The Load Balancer (100.64.10.1) (25) within Subnet 1 ensures that requests related to TEE processing are efficiently distributed across the network, optimizing both performance and scalability.

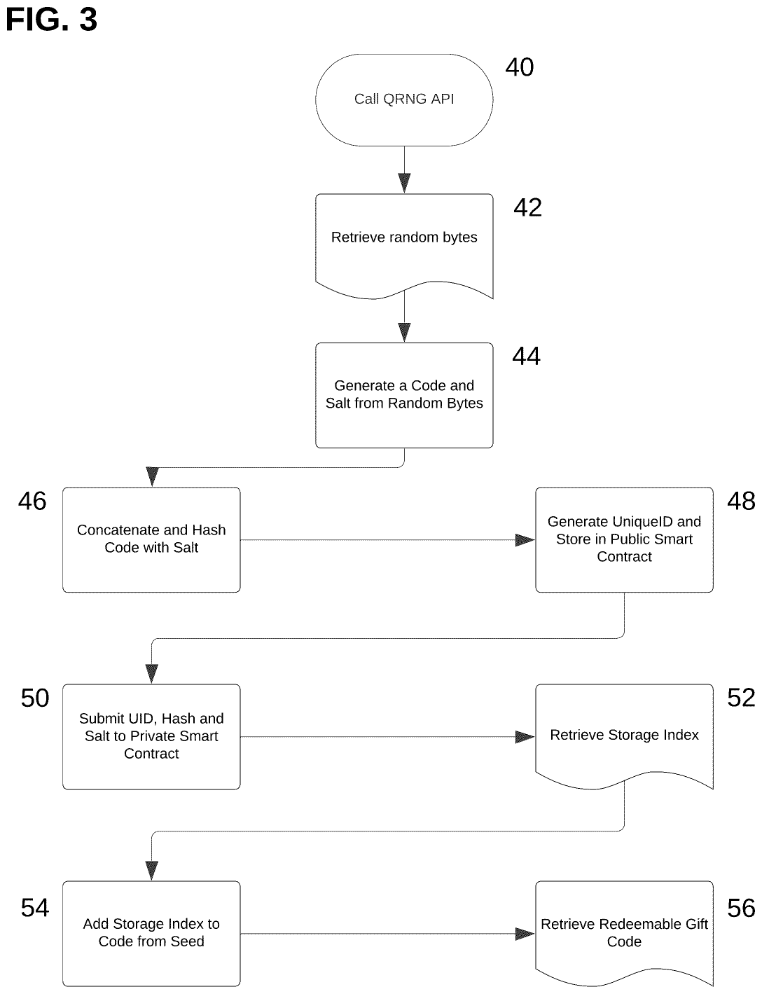

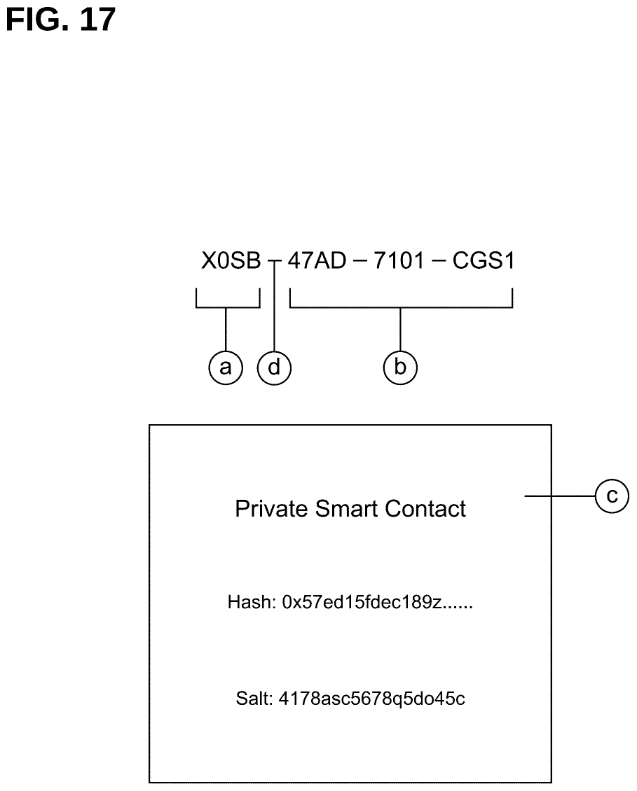

FIG. 1 illustrates a flowchart of the process of the present invention. FIG. 1 illustrates the initial step for subprocesses of the method of the present invention. Each step within FIG. 1 can be performed in a variety of ways, which will be described in a non-limiting manner, using subprocesses shown in FIGS. 3 through 16, also using FIG. 2 illustrating Network Topology, while FIGS. 17-25 illustrates Digital and Physical Cards and Smart Contracts. Starting at step 10 of FIG. 1 to “Generate Gift Code”, working our way down to the bottom at step 38 of FIG. 1 where a user is granted access to redeemable content using a valid Redeemable Code. It is important to note all steps that involve writing or reading a blockchain state occur through the use of a transaction on the network triggered using an Externally Owned Wallet or a Smart contract which can also act as a wallet.

At step 10 of FIG. 1 a user generates a Redeemable Gift Code either on their local computer hardware or this can also take place server side via API endpoint calls. FIG. 3 illustrates a subprocess of how a user can securely generate Redeemable Gift code(s) using random bytes returned by calling a Quantum Random Number Generator API endpoint step 40 which may be hosted within Network Topology of step 13 of FIG. 2 Cryft API VM. The QRNG returns one or more strings of random bytes at step 42 of FIG. 3 that then can be utilized as the seed to result in a variable length Alpha and or Numeric Code string, or even a salt at step 44 of FIG. 3 which can be concatenated and hashed with the variable length alpha and or numeric code at step 46 of FIG. 3. The resulting hash and salt used in the hashing process are then associated with a Unique Identifier of no specific format by storing the status and UID in a public smart contract at step 48 of FIG. 3 using a public RPC node in step 19 of FIG. 2 and the same UID along with the Hash, Salt and any other relevant details are then stored at a storage index within a private smart contract at step 50 of FIG. 3 using a call the secure API VM at step 11 of FIG. 2 which utilizes the private RPC node at step (27) of FIG. 2. The storage index assigned within the private smart contract located in the tessera node at steps 21 and 23 of FIG. 2 is then returned to, or already known by the submitting user at step 52 of FIG. 3. This storage index is then added to the Alpha and or numeric code generated from the QRNG seed at step 54 of FIG. 3 to result in a functionally redeemable and manageable Gift Code at step 56 of FIG. 3 as visualized in FIG. 17 label a. Completing steps up to the shown example in step 14 of FIG. 1.

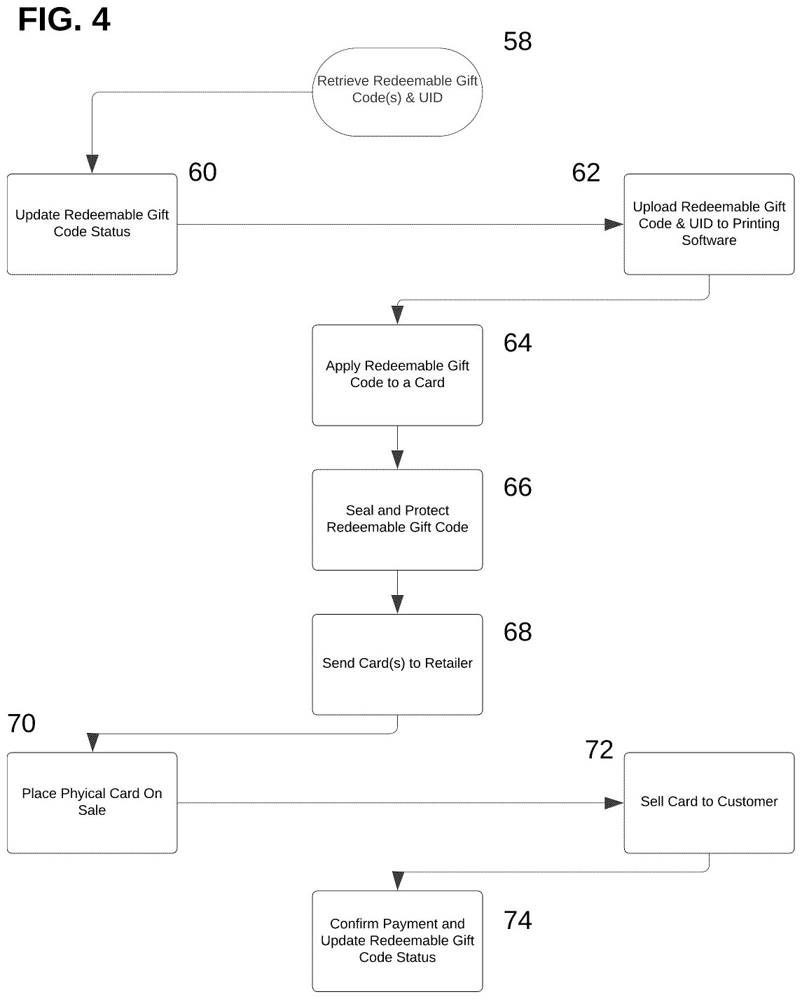

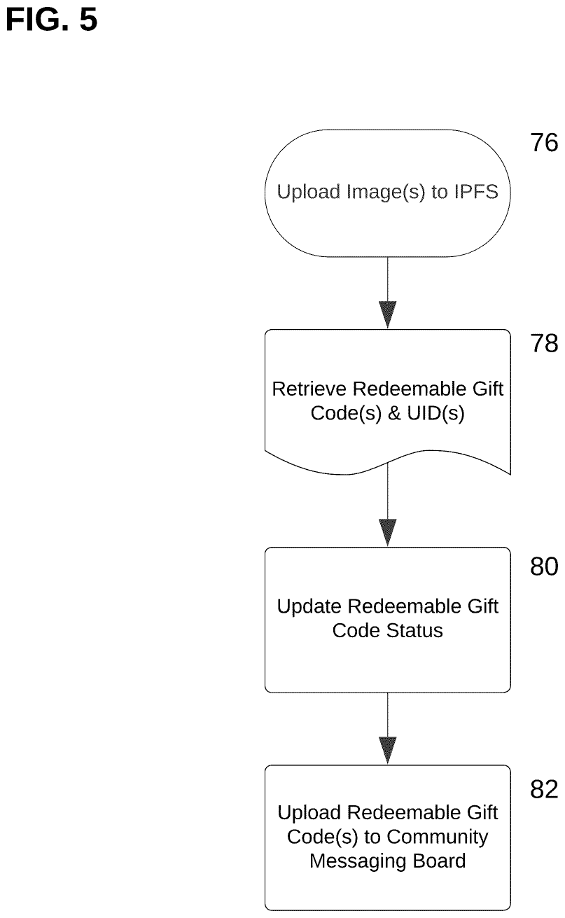

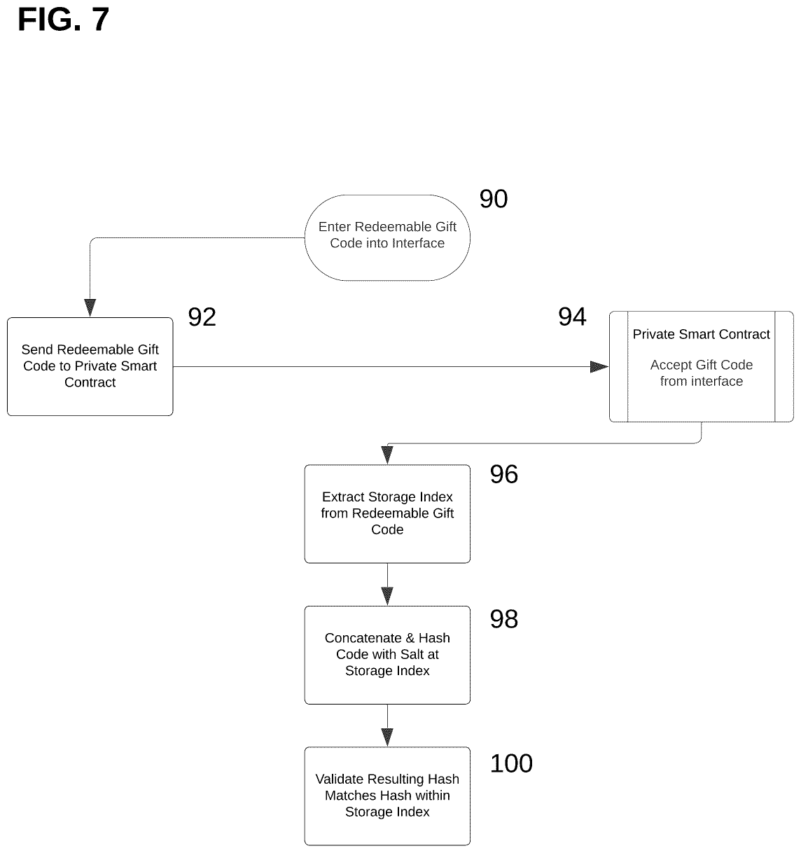

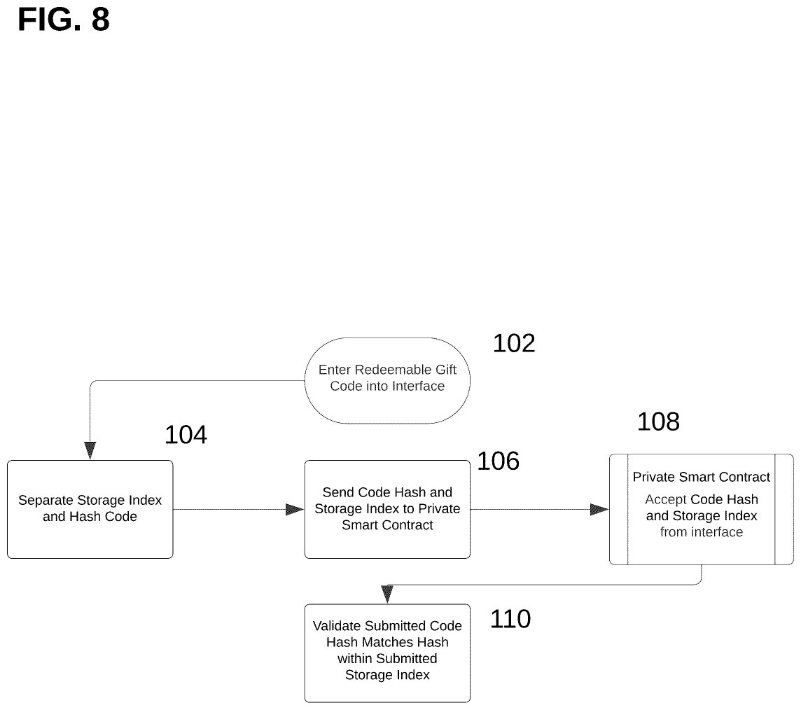

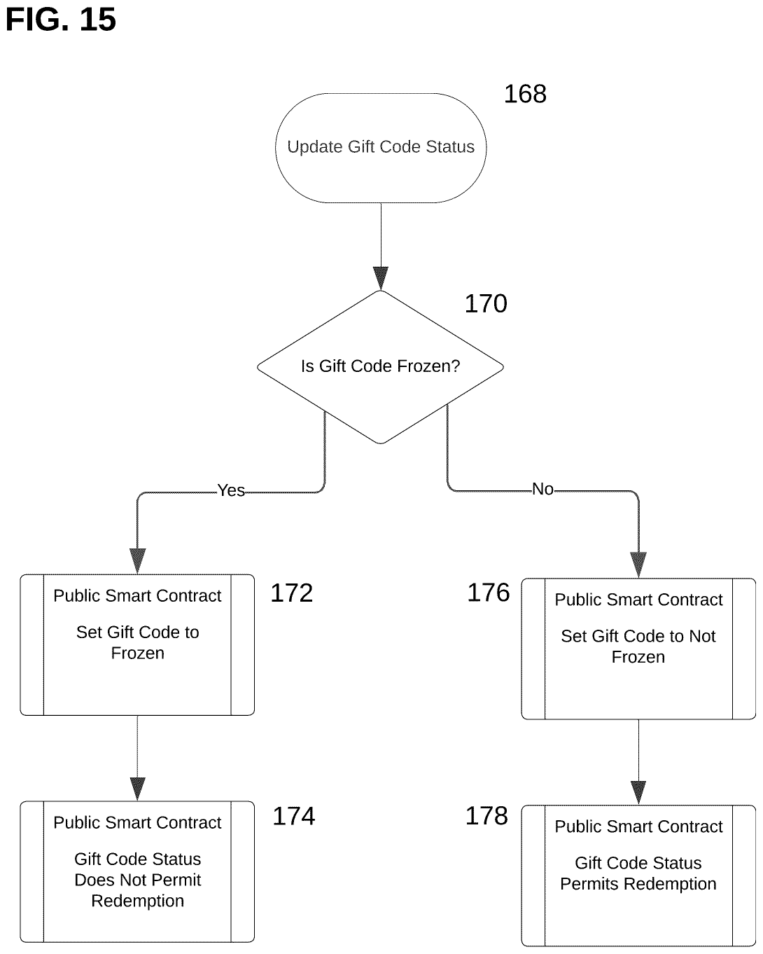

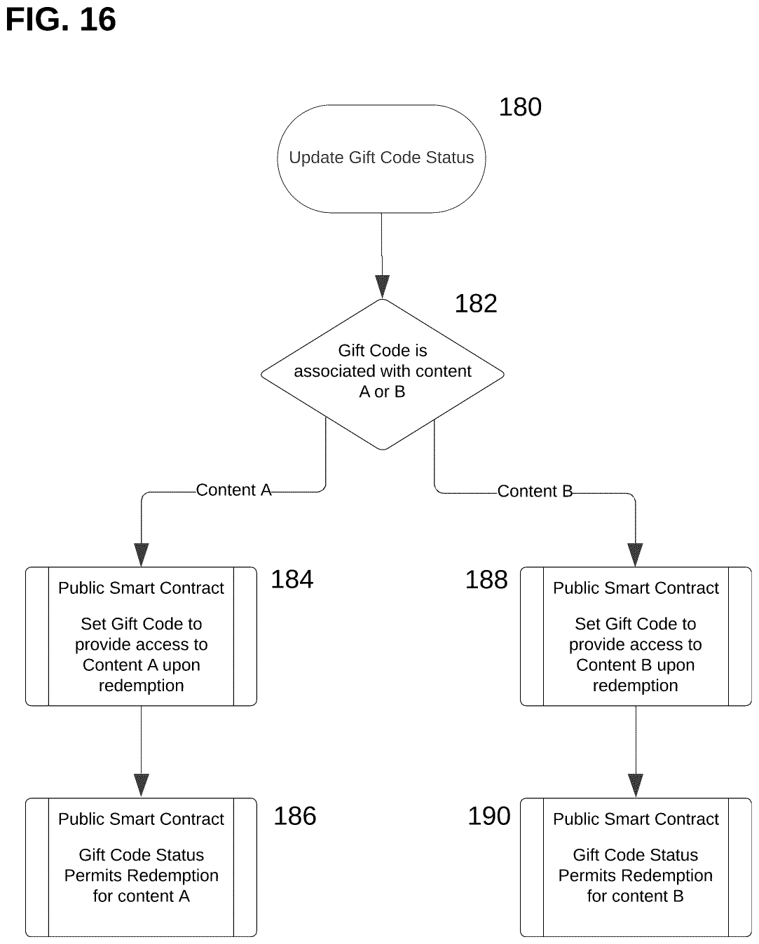

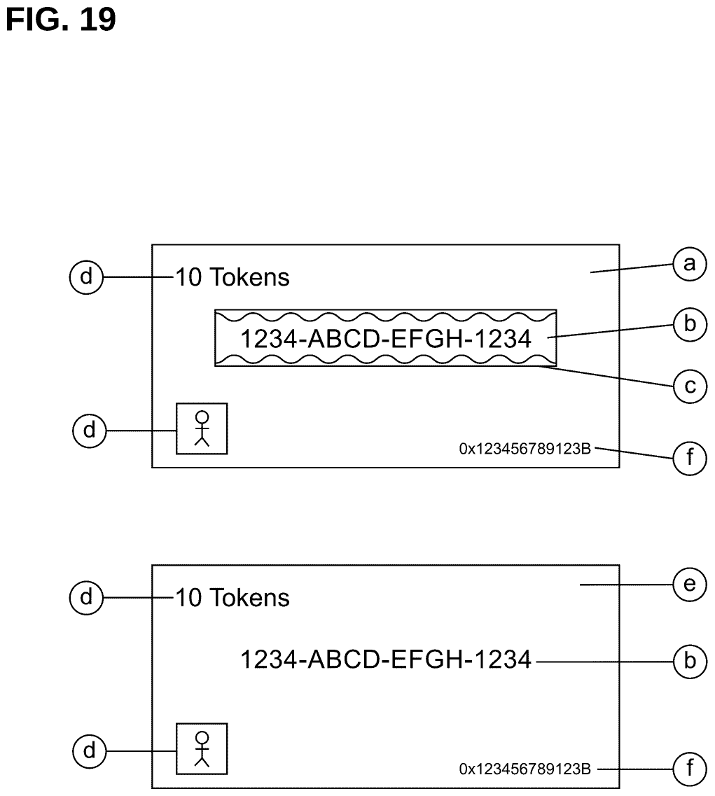

Now that the Redeemable Gift Code has been generated, stored as a hash/salt combo in a private smart contract as visualized in FIG. 17 label c and associated with a unique identifier in a public smart contract, authorized users can manage redeemable gift codes from the public smart contract and apply the redeemable gift code on either a physical or digital medium at step 16 and distribute to users at step 18 of FIG. 1. The process of distributing the redeemable gift code can be seen in FIG. 4 subprocess illustration for physical cards and FIG. 5 subprocess illustration for digital cards. As shown in step 58 subprocess of FIG. 4, one can retrieve the redeemable gift code and its UID from actions used in FIG. 3 subprocess and update the public Redeemable Gift Code status using a transaction sent through public RPC node in step 19 of FIG. 2 assigning redeemable content to the redeemable gift code step 60 of FIG. 4 like shown in subprocess of FIG. 16. Once the redeemable gift code has a status assigning content to its UID, one can upload the redeemable gift code and even the UID to printing software and alike step 62 of FIG. 4 and apply these details to a physical card at step 64 of FIG. 4. One can then optionally cover and protect the sensitive redeemable gift code at step 66 of FIG. 4 and send the card to a retailer step 68 of FIG. 4. The retailer then acting as an authorized manager of a redeemable code can place the card for sale to the public at step 70 of FIG. 4. Once one buys the card at step 72 of FIG. 4, the retailer acting as an authorized manager for the redeemable gift code can update the public status to not frozen as shown in FIG. 15 subprocess, allowing the code to then be redeemed as or like shown in steps 22-28 of FIG. 1 and subprocess illustrated in FIG. 7 or 8. Non-limiting examples of physical cards can be seen in FIGS. 19-23).

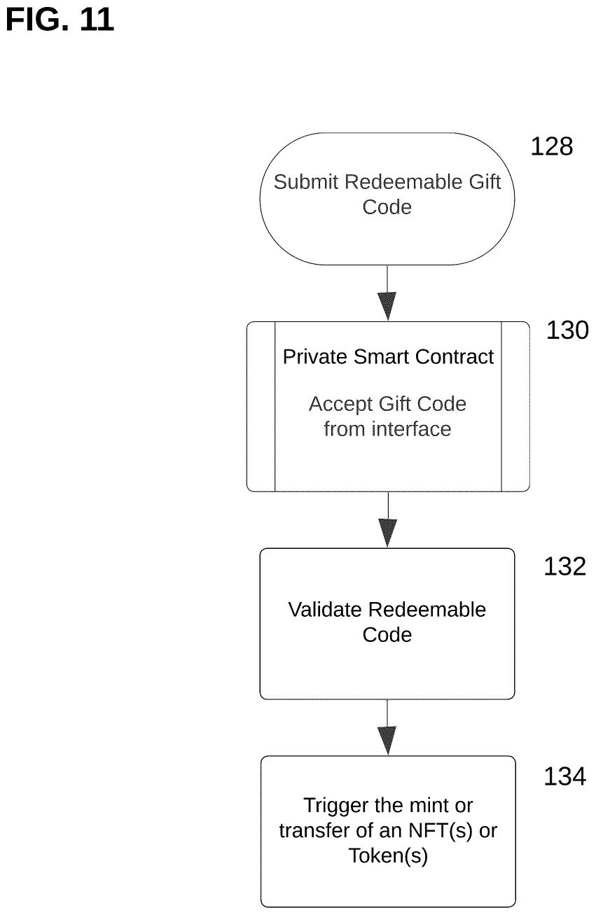

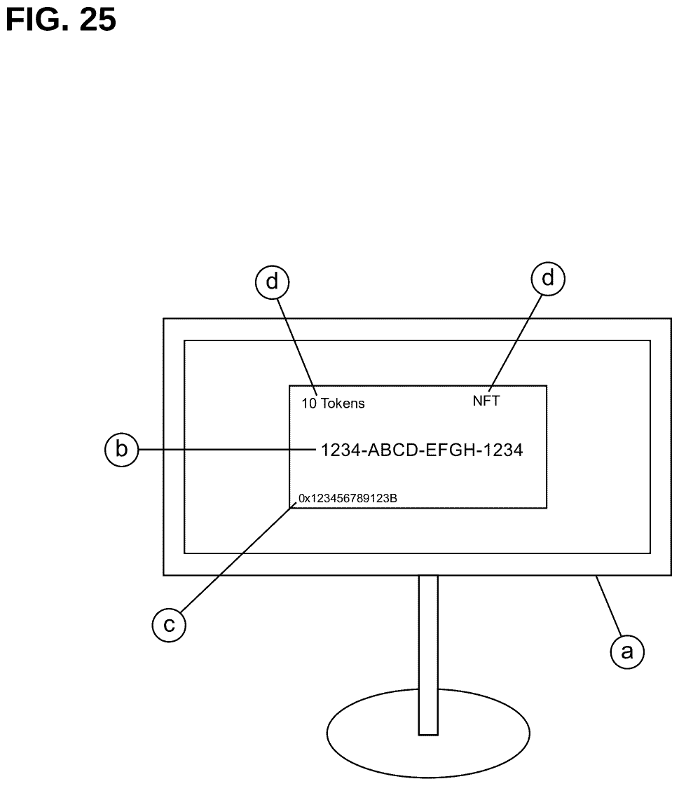

As previously stated the redeemable gift code can also be applied as a digital card as shown in FIG. 5 subprocess. As shown in step 76 of FIG. 5, one can upload an image to the IPFS (interplanetary file storage) and retrieve the redeemable gift code and its UID at step 78 in FIG. 5 from actions used in subprocess FIG. 3 and update the public Redeemable Gift Code status using a transaction sent through public RPC node in step 19 of FIG. 2 assigning redeemable content (like the image uploaded to the IPFS) to the redeemable gift code step 80 of FIG. 5 like shown in FIG. 16. This redeemable gift code will result in the redeemer receiving an NFT token upon redemption as shown in FIG. 11 subprocess, giving ownership of the IPFS hosted image to the redeemer. The digital redeemable gift code can be shared as a plain text card in a community messaging board step 82 of FIG. 5 where one may acquire the redeemable gift code and submit to the redemption interface allowing the code to then be redeemed as or like shown in FIG. 1 (steps 22-28) and FIG. 7 or 8 subprocesses. While digital cards can take any digital form like text or even a Jpeg, an example of a digital media card can be seen in FIG. 25.

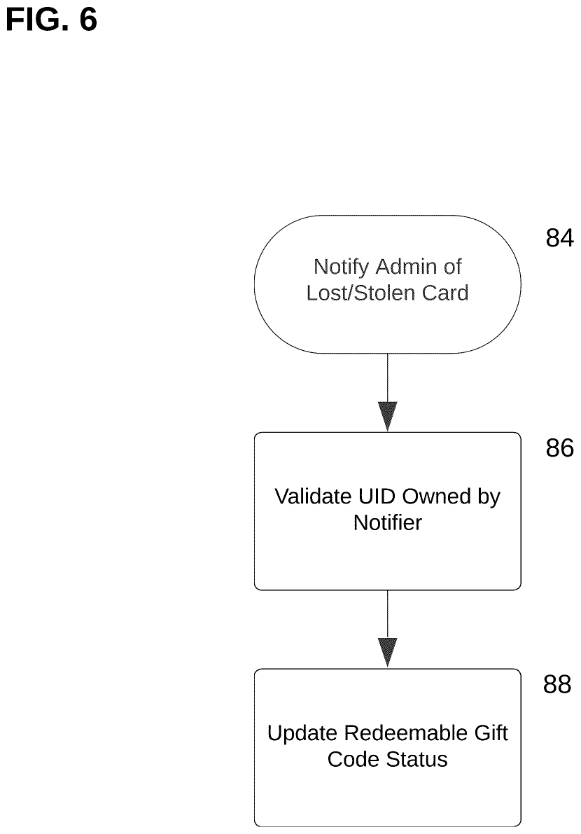

As shown in FIG. 6 subprocess, one of the many advantages of using this invention is the ability for one to notify an administrator of a lost or stolen physical or digital card which is being subsequently frozen to prevent loss. Physical and digital cards can have their public status managed by authorized users as shown in FIGS. 15 and 16 subprocesses so that lost or stolen cards fail step 28 of FIG. 1. One can notify admin of a lost card in step 84 of FIG. 6 who will then validate the UID of lost/stolen card is owned by the notifier step 86 of FIG. 6 and submit a transaction via the public RPC node in step 19 of FIG. 2 to freeze the redeemable code ability to be redeemed.

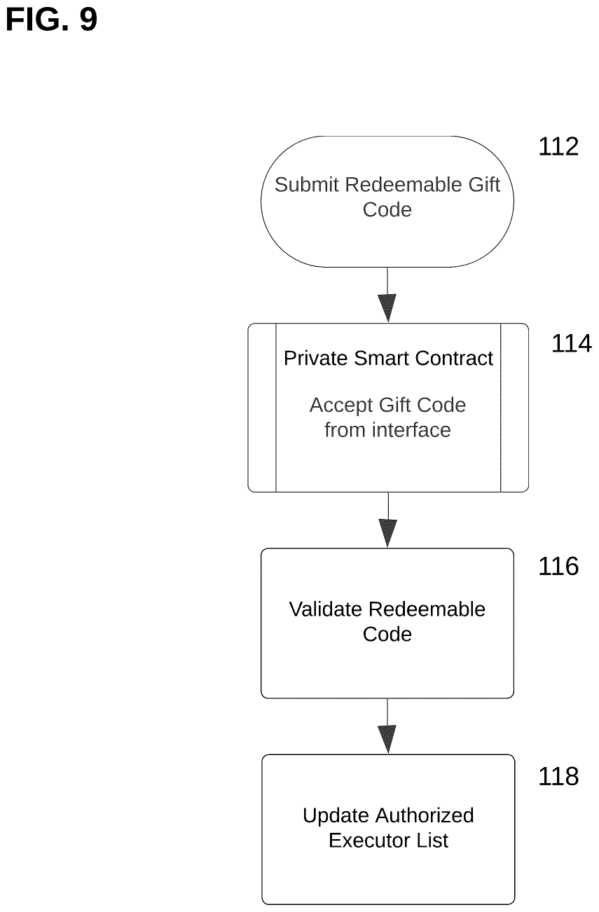

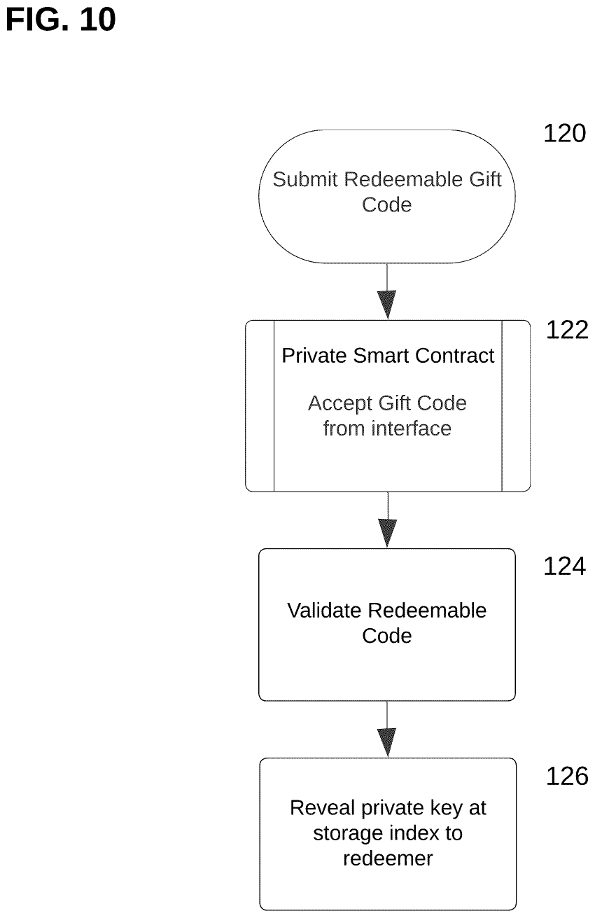

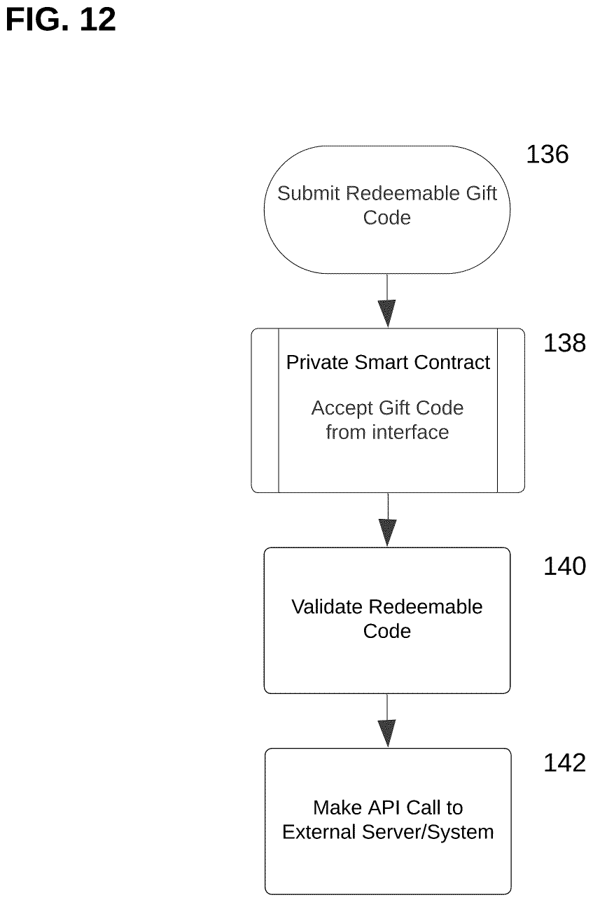

The greatest advantage of this invention is how the redeemable gift codes can be assigned a very wide range of redeemable content using the associated UID and status within a public smart contract. Ranging from access to physical and digital experiences to certification of ownership of physical or digital items like a digital NFT or even a physical piece of art. Shown in FIGS. 9-12 subprocesses, we can see in a non-limiting way how this invention can be applied to a variety of redeemable content. In FIGS. 9-12 subprocesses, each first three steps are assumed to be the same for each illustration as follows. The first step in each subprocess in FIGS. 9-12 is a trigger from a redeemer submitting a redeemable gift code through an interface that then transmits the redeemable code through the Secure API shown in Topology FIG. 2 which then forwards the redeemable code to the private RPC endpoint step 27 of FIG. 2. The redeemable code in subprocesses shown in FIGS. 9-12 is then accepted in the second step in FIGS. 9-12 by the smart contract and processed and validated in the third step using the flow from FIG. 1 step 24-28 and subprocesses shown in FIG. 7 or 8. But the differing piece in subprocesses shown in fourth step in FIGS. 9-12. In FIG. 9 subprocess the fourth step adds the public wallet address of the redeemer to a list of authorized executors allowed to access digital content within a smart contract-based wallet. In the fourth step illustrated in FIG. 10 subprocess, the fourth step shows the valid redemption returning the private key of an externally owned account containing digital assets like tokens to the redeemer, giving them access to redeemable content. In FIG. 11 subprocess, the fourth step shows the minting and or transfer of a token or tokens to the wallet address or a middle man associated with the redeemer, giving access to the redeemable content. In FIG. 12 subprocess the fourth step shows the validated redemption can trigger any external API resulting in a redeemable experience or content physical to digital. It is important to note the fourth step in FIGS. 9-12 subprocesses is not limiting nor fully encompassing all possible redeemable contents.

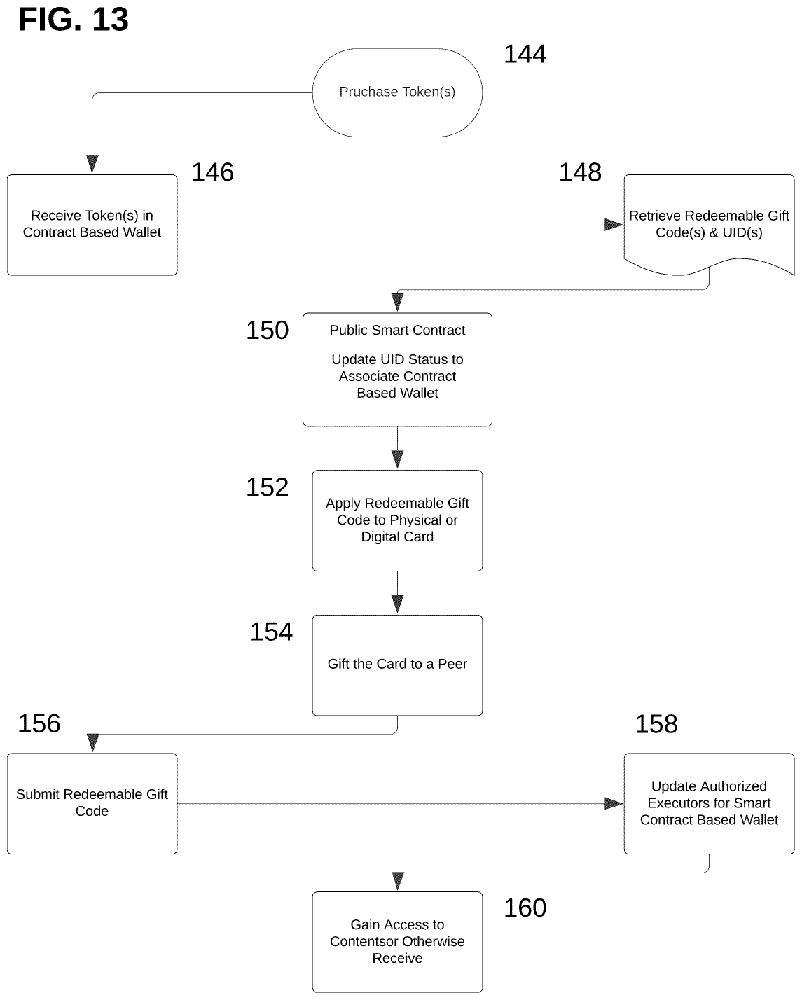

Another important and non-limiting aspect of this invention can be described using FIG. 13 subprocess. In FIG. 13 subprocess you can see how a user can purchase a token(s) in step 144 of FIG. 13 subprocess from the open market or a centralized reseller and gift them using a redeemable gift code and smart contract wallet. Once payment is completed, the token(s) will transfer to a smart contract-based wallet in step 146 of FIG. 13 which may be assigned an authorized admin. Then a user can retrieve the redeemable gift code and UID at step 148 of FIG. 13 using a subprocess like we see in FIG. 3 subprocess. Once the UID is retrieved, the authorized admin can update the public status of the redeemable code's UID and associate the redeemable code with the smart contract wallet holding the tokens(s) in step 150 of FIG. 13. Then the user can (if not done automatically) apply the redeemable gift code and optionally the UID to a digital or physical card in step 152 of FIG. 13. Then the user can gift or otherwise give the card to a peer at step 154 of FIG. 13. The receiver of the card can then submit the redeemable code to an interface like in step 20 of FIG. 1 for processing and validation in step 156 of FIG. 13 like we see in FIG. 7 or 8 subprocesses. Once validation of the redeemable code completes, an API call will trigger a transaction to add the redeemer to a list of authorized executors with access to the smart contract wallet assigned to the UID step 158 of FIG. 13. With the redeemer of the redeemable gift now set as an authorized executor, the authorized executor now has access to the token(s) within the smart contract wallet step 160 of FIG. 13. An authorized executor can be defined many ways, not limited to a list, but also the holder and another token can be considered an authorized executor.

In FIG. 15 subprocess, the illustration depicts a flow chart which shows us how an admin may freeze or unfreeze a Gift Code by updating the Gift Codes status within the public smart contract, influencing the outcome of the redemption process shown in FIG. 1. If an admin freezes a Gift Code by referencing its Unique ID in a public smart contract, the Gift Code will fail step 28 of FIG. 1. In step 168 of FIG. 15 an admin updates the status of a Gift Code in a public smart contract. In step 170 if the Gift Code is set to frozen at step 172 then the Gift Code will not be permitted to be redeemed at step 174. In step at step 170 if the Gift Code is set to not frozen at step 176 then the Gift Code will be permitted to be redeemed at step 178. The transaction to trigger the status change is executed through an RPC endpoint as seen in step 19 of FIG. 2.

In FIG. 16 subprocess illustrated is a flow chart that shows how an admin may change what the redeemable Gift Code results in by updating the Gift Codes status within the public smart contract, influencing the outcome of the redemption process shown in FIG. 1. If an admin assigned Content A to a Gift Code by referencing its Unique ID in a public smart contract, the Gift Code will result in access to Content A in step 38 of FIG. 1. In step 180 of FIG. 16 an admin updates the status of a Gift Code in a public smart contract. In step 182 of FIG. 16, if the Gift Code is assigned to Content A at step 184, then the Gift Code will provide access to Content A once redeemed at step 186. In step 182, if the Gift Code is assigned Content B at step 188, then the Gift Code will provide access to Content B once redeemed at step 190. The transaction to trigger the status change is executed through an RPC endpoint as seen in step 19 of FIG. 2.

Referring now to FIGS. 17-25, FIG. 17 illustrates a clear text alphanumeric Gift Code and exemplifies the Gift Codes structure. The label (a) is the first portion of the Gift Code used as an alpha and or numeric index of no specific character length used as a location identifier to locate the second portion of the Gift Code stored as a hash and salt pair (or other encrypted representation) for later decoding upon redemption. The label (b) is the second portion of the Gift Code that is stored in the private contract as a hash and salt pair (or other encrypted representation) which was located by the index of the Gift Code. The label (c) is an example detail of how the hash and salt pair look while stored in the private smart contracts state. The label (d) is optional dashes added to the code only to help improve human readability and user experience.

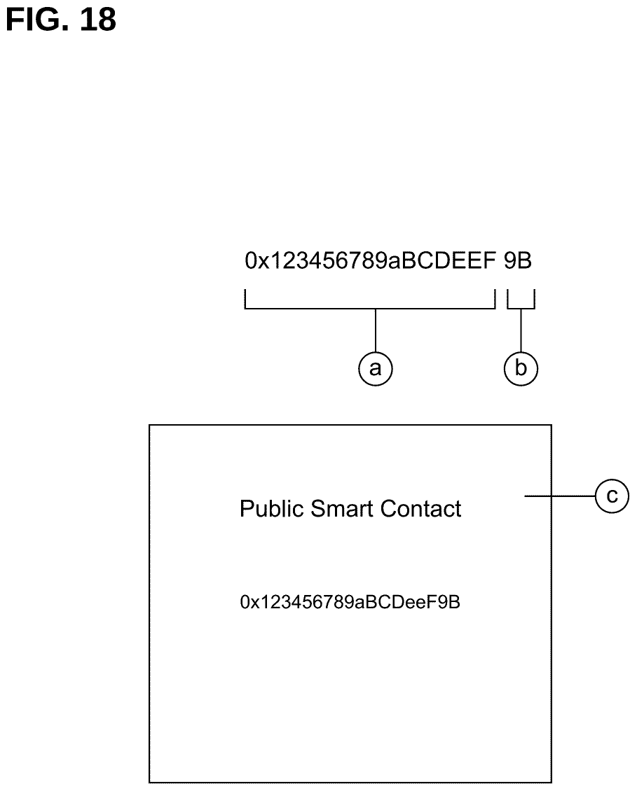

FIG. 18 illustrates a unique identifier generated from but not limited to an ethereum wallet or contract address, which facilitates the management of a specific code. This identifier includes an index, correlating to a particular Gift Code for management. It enables the management and referencing of the Gift Code within a public contract state, without revealing the clear text code on the card or the encrypted hashed code within the private smart contract state. The label (a) illustrates how the unique ID contains a but not limited to blockchain address or even group/user ID of no specific character length or format which identifies the manager(s) of the code which has permission to do, or grant permission to do things like but not limited to freezing and unfreezing the Gift Code or even defining the redeemable content. The label (b) illustrates the alpha and or numeric index ID of no specific character length or structure added to the end of the wallet address (or group/user ID) to narrow down which gift code the manager (as defined by the group/user or wallet address ID) intends to interact with. The label (c) shows how the unique identifier looks within the public smart contract and is used to reference the stored Gift Code.

FIG. 19 depicts two cards with the basic shape and size of a business card made of no specific material containing the clear text Gift Code with one that is covered by an optional scratch off or peel off covering and the other without the scratch off or peel off covering (digital and physical cards can but will not always display their associated unique ID). The label (a) is a card made of no specific material in the shape of a business card with the optional removable covering to prevent undesired exposure of the gift code. This labeled (b) is a clear text alphanumeric gift code located on the card. The labeled (c) is the optional covering intended to protect the clear text Gift Code until revealed by the redeemer. The label (d) is artwork and text related to the NFT and or tokens/coins we receive when redeemed. The label (e) is a card made of no specific material in the shape of a business card without the optional covering. This labeled (f) is the optionally placed unique ID associated with the Gift Code on the card.

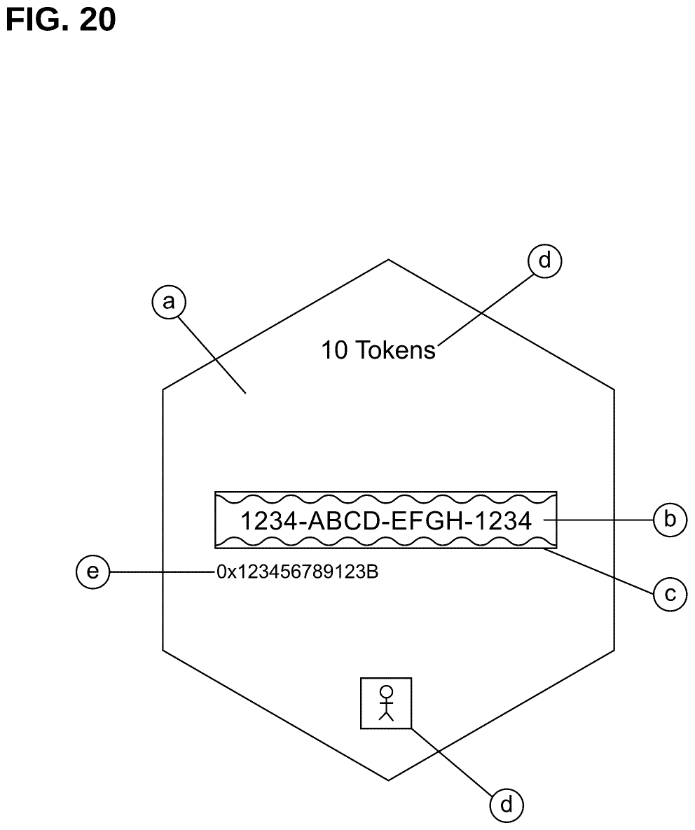

FIG. 20 illustrates an odd non-standard shaped card made of no specific material containing the clear text Gift Code that is covered by an optional covering to protect undesired exposure of the gift code (digital and physical cards can but will not always display their associated unique ID). The label (a) is a card made of no specific material in an odd non-standard shape. This labeled (b) is a clear text alphanumeric gift code located on the card. This labeled (c) is the optional covering intended to protect the clear text or even but not limited to or encoded clear text gift code until revealed by the redeemer. The label (d) is artwork and text related to the NFT and or tokens/coins we receive when redeemed. This labeled (e) is the optionally placed unique ID associated with the Gift Code on the card.

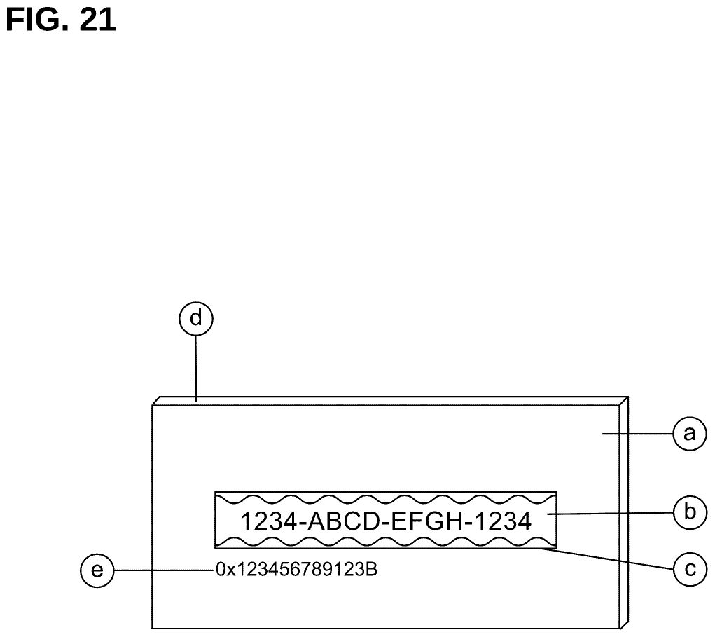

FIG. 21 illustrates a sticker made of no specific material and an adhesive backing meant to be applied to various objects (digital and physical cards can but will not always display their associated unique ID). This labeled (a) card is made of no specific material with an adhesive backing. This labeled (b) is a clear text alphanumeric gift code located on the card. This labeled (c) is the optional covering intended to protect the clear text Gift Code until revealed by the redeemer. The label (d) is the adhesive backing. This labeled (e) is the optionally placed unique ID associated with the Gift Code on the card.

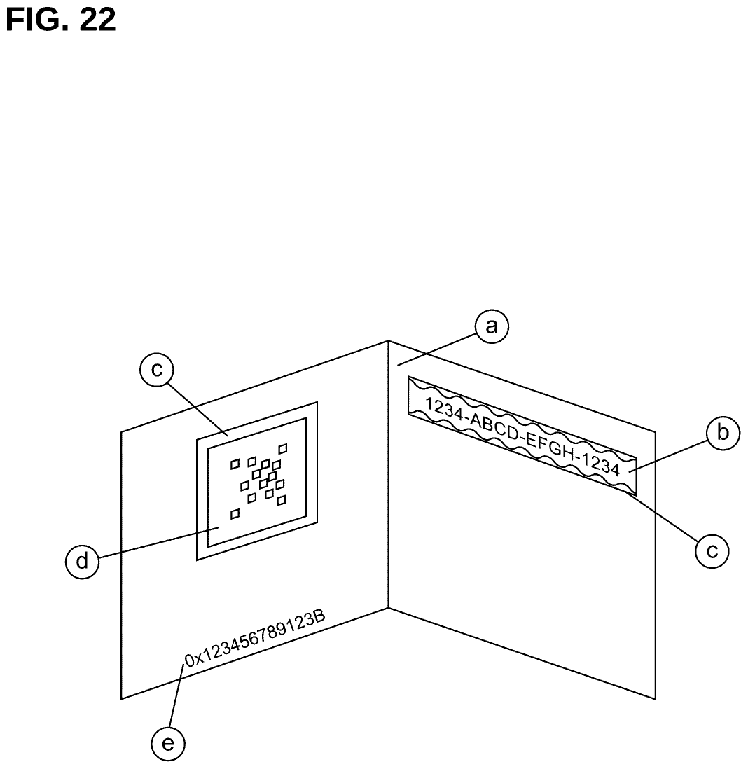

FIG. 22 illustrates a bifold card of no specific material with Figures on the front with the clear text Gift Code that is covered by an optional covering on the interior (digital and physical cards can but will not always display their associated unique ID). This label (a) is a card made of no specific material with the shape commonly but not always used in greeting cards with a bifold shape. This labeled (b) is a clear text alphanumeric gift code located on the card. The label (c) is the optional covering intended to protect the clear text Gift Code until revealed by the redeemer. The label (d) is a QR code which contains the clear text Gift Code and or a link to the website where the Gift Code is to be redeemed. This labeled (e) is the optionally unique ID associated with the Gift Code on the card.

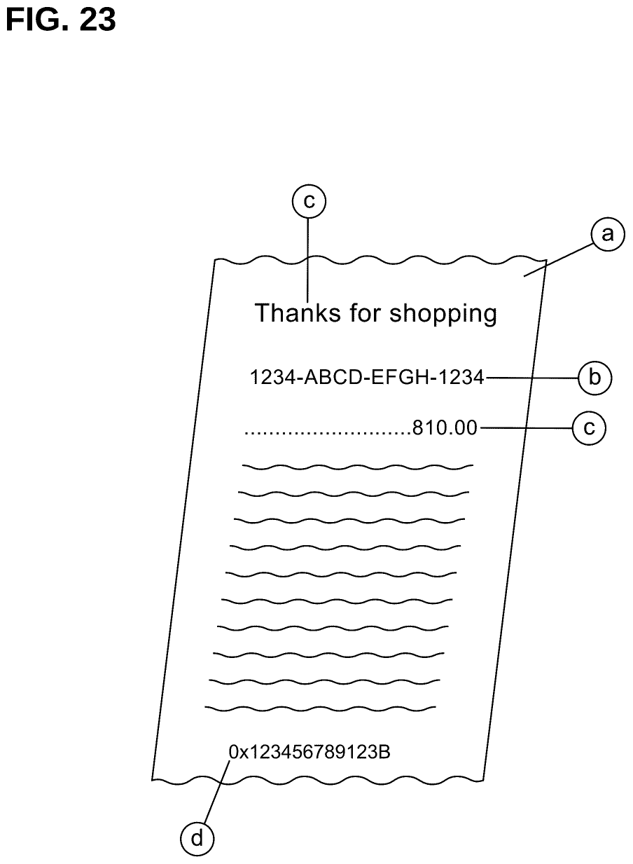

FIG. 23 illustrates a transaction receipt made of no specific material that has been printed and contains a redeemable Gift Code (digital and physical cards can but will not always display their associated unique ID). This is the receipt labeled (a) made of no specific material. This is the Gift code labeled (b) on the receipt either printed via thermal or standard ink. This labeled (c) is the transaction summary you typically expect to see on a transaction-based receipt. This labeled (d) is the unique ID associated with the Gift Code on the card.

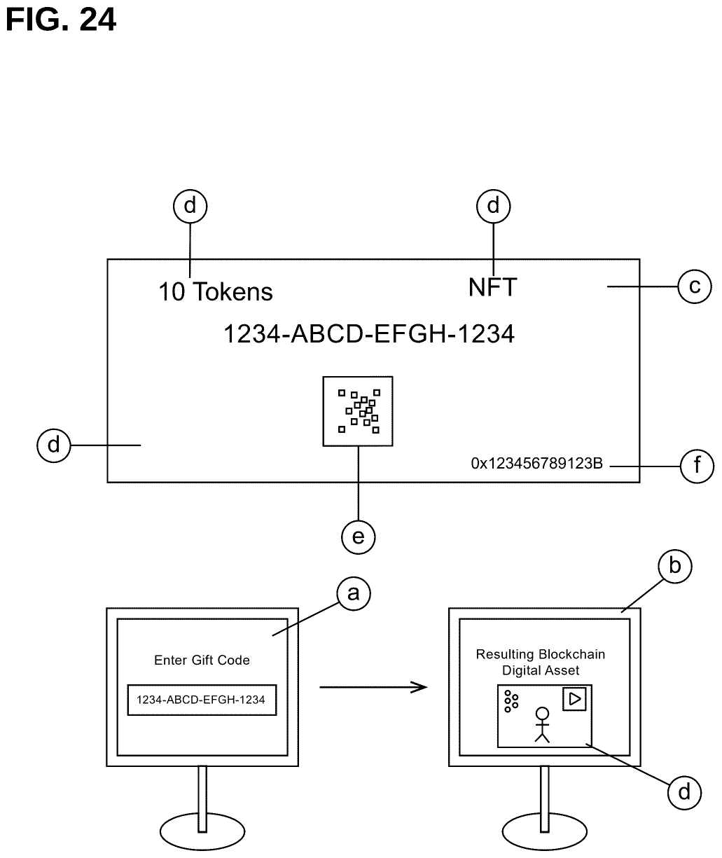

FIG. 24 illustrates a computer screen which shows the Gift Code being entered into an input field for redemption and then the resulting NFT and the accompanying card. This is the computer screen labeled (a) containing the input interface on the website where we enter the Gift Code for redemption. This is the computer screen labeled (b) containing the resulting NFT which contains any number of digital assets on the blockchain. This is a card made of no specific material labeled (c) containing a clear text Gift Code that matches the code displayed in the input interface. This is a way labeled (d), to depict the content of the card once redeemed. This label (e) is a QR code which can contain but is not limited to containing a Gift Code and or a link to the website or platform on which the gift code is entered. This labeled (f) is the unique ID associated with the Gift Code on the card.

FIG. 25 illustrates a computer screen that contains a digital card which displays a Gift Code and the associated unique ID (digital and physical cards can but will not always display their associated unique ID). This is the computer screen labeled (a) containing the digital card in no specific file format. This is the Gift code labeled (b) on the digital card. This labeled (c) is the optionally placed unique ID associated with the Gift Code on the card. This labeled (d) is various types of digital blockchain assets associated with the digital card.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. A method for managing gift card codes, comprising the steps of:
generating a gift code;
generating a unique identification code to be associated with a smart public contract in a blockchain;
associating the gift code with a storage index and the unique identification code from smart public contract within a smart private contract of a blockchain;
applying gift code to a gift card;
distributing digital code to a recipient;
entering gift code into a redemption interface; and
accepting gift code from the redemption interface and checking validity within the smart private contract.

2. The method for managing gift card codes of claim 1, wherein the gift card is a physical card.

3. The method for managing gift card codes of claim 1, wherein the gift card is a digital card.

4. The method for managing gift card codes of claim 1, further comprising the step of:
checking if gift code is active if gift code is valid.

5. The method for managing gift card codes of claim 4, further comprising the step of:
permitting redemption if gift code is active as indicated in public smart contract;
updating public and private smart contracts with redemption status if gift code is active; and
providing access to redeemable contact if gift code is active.
